(19) United States
(12) Patent Application Publication
(10) Pub. No.: US 2026/0137967 A1
(43) Pub. Date: May 21, 2026

(54) CLAMPING ASSEMBLY FOR A FALL RESTRAINT SYSTEM OF A TRAILER

(71) Applicant: JMC Enterprises, Inc., Syracuse, NY (US)

(72) Inventors: Jonathan Campbell, La Fayette, NY (US); Joseph Palumbo, East Syracuse, NY (US)

(21) Appl. No.: 19/371,208

(22) Filed: Oct. 28, 2025

Related U.S. Application Data
(60) Provisional application No. 63/721,629, filed on Nov. 18, 2024.

(51) Int. Cl. A62B 35/00; B25B 5/10; B25B 5/16

(52) U.S. Cl. CPC A62B 35/0068; B25B 5/102; B25B 5/109; B25B 5/166

(57) ABSTRACT

A clamping assembly for a fall restraint system, the clamping assembly including an arm, including a first end, a second end, and a slot, a first engaging member slidably connected to the arm, the first engaging member displaceable in a first direction and a second direction, opposite the first direction, a plate including a first surface connected to the first end and a second surface, a first tensioning device operatively arranged to displace the first engaging member in the first direction, and a coupling device connected to the second surface.

### CROSS-SECTION TO RELATED APPLICATIONS

This application claims the benefit under 35 U.S.C. § 119(e) of U.S. Provisional Application No. 63/721,629, filed November 18, 2024, which application is incorporated herein by reference in its entirety.

### FIELD

The present disclosure relates to safety apparatuses, and more particularly, to a fall restraint assembly including a clamping assembly for use with semi-trailers and other tall structures that prevents injury from falling.

### BACKGROUND

In geographic areas of significant snowfall, snow and ice on the roof of semi-trailers, also known as tractor-trailers, and other heavy machinery presents a significant driving hazard. Snow and ice accumulation on the roof of vehicles can come dislodged at driving speed and become airborne. This snow and ice can then cause significant harm to other vehicles and their occupants. Snow removal from semi-trailers prior to driving is currently mandated by the U.S. Department of Transportation in many northern states.

Current technology relies on a scraper system where semi-trailers travel underneath a fixed or moveable bar that removes the snow from the roof of the semi-trailer as it passes through the structure. However, these systems do not always completely remove ice and packed snow from the roof structure of the trailer and thus still present a hazard to other drivers.

In many instances it is necessary for a person to physically get on the roof of the semi-trailer to break up and remove ice and snow to best make the trailer safe. However, traversing the top of a semi-trailer that is covered in deep snow or ice also presents a significant hazard. Slippery conditions that are often accompanied by cold temperatures and reduced visibility present a harsh work environment and significant risk of a fall from the roof of the trailer.

### SUMMARY

It is an object of the present disclosure to provide a clamping assembly for a fall restraint system of a trailer.

The present disclosure is directed to one or more exemplary embodiments of a clamping assembly for a fall restraint system.

The clamping assembly comprises an arm, including, a first end, a second end, and a slot, a first engaging member slidably connected to the arm, the first engaging member displaceable in a first direction and a second direction, opposite the first direction, a plate including a first surface connected to the first end and a second surface, a first tensioning device operatively arranged to displace the first engaging member in the first direction, and a coupling device connected to the second surface.

In an exemplary embodiment, the first engaging member comprises a first top bracket including a first finger and a second finger spaced apart from the first finger. In an exemplary embodiment, the first top bracket comprises a post and the first finger and the second finger extend from the post in the first direction. In an exemplary embodiment, the first engaging member further comprises a first bottom bracket, and a connector extends through the first bottom bracket, the slot, and the first top bracket to slidably connect the first engaging member to the arm.

In an exemplary embodiment, the first tensioning device comprises a rod connected to the first engaging member. In an exemplary embodiment, the rod comprises threading and is threadably engaged with the second end. In an exemplary embodiment, the clamping assembly further comprises a second engaging member slidably connected to the arm, the second engaging member displaceable in the first direction and the second direction. In an exemplary embodiment, the clamping assembly further comprises a second tensioning device operatively arranged to displace the second engaging member in the second direction. In an exemplary embodiment, the second engaging member comprises a second top bracket including a third finger and a fourth finger spaced apart from the third finger.

In an exemplary embodiment, the clamping assembly further comprises a second tensioning device operatively arranged to displace the second engaging member in the second direction. In an exemplary embodiment, the second tensioning device comprises a rod connected to the second engaging member. In an exemplary embodiment, the rod comprises threading and is threadably engaged with a hole in the plate. In an exemplary embodiment, the first surface comprises a rubber pad. In an exemplary embodiment, the coupling device comprises an eyebolt.

The present disclosure is directed to one or more exemplary embodiments of a fall restraint system.

In an exemplary embodiment, the fall restraint assembly comprises a clamping assembly, including an arm, including a first end, a second end, and a slot, a first engaging member slidably connected to the arm, the first engaging member displaceable in a first direction and a second direction, opposite the first direction, a plate including a first surface connected to the first end and a second surface, a first tensioning device operatively arranged to displace the first engaging member in the first direction, and a coupling device connected to the second surface, and a line connected to the coupling device.

In an exemplary embodiment, the first engaging member comprises a first finger and a second finger spaced apart from the first finger, the first finger and the second finger extending in the first direction. In an exemplary embodiment, the fall restraint assembly further comprises a second engaging member slidably connected to the arm. In an exemplary embodiment, the second engaging member comprises a third finger and a fourth finger spaced apart from the third finger, the third finger and the fourth finger extending in the second direction. In an exemplary embodiment, the fall restraint assembly further comprises a second tensioning device operatively arranged to displace the second engaging member in the second direction. In an exemplary embodiment, the first tensioning device comprises a rod connected to the first engaging member, and the rod is threadably engaged with one of the first end and the second end.

These and other objects, features, and advantages of the present disclosure will become readily apparent upon a review of the following detailed description of the disclosure, in view of the drawings and appended claims.

### BRIEF DESCRIPTION OF THE DRAWING

The accompanying drawings are incorporated herein as part of the specification. The drawings described herein illustrate embodiments of the presently disclosed subject matter and are illustrative of selected principles and teachings of the present disclosure, in which corresponding reference symbols indicate corresponding parts. However, the drawings do not illustrate all possible implementations of the presently disclosed subject matter and are not intended to limit the scope of the present disclosure in any way.

FIG. 1 is a front perspective view of a fall restraint assembly, in accordance with embodiments of the present disclosure.

FIG. 2 is a front perspective view of a fall restraint assembly, in accordance with embodiments of the present disclosure.

FIG. 3A is a front perspective view of the clamping assembly shown in FIG. 1.

FIG. 3B is a rear perspective view of the clamping assembly shown in FIG. 1.

FIG. 3C is a side elevational view of the clamping assembly shown in FIG. 1.

FIG. 3D is a top plan view of the clamping assembly shown in FIG. 1.

FIG. 3E is a front elevational view of the clamping assembly shown in FIG. 1, with the tensioning device and attachment device removed.

FIG. 3F is a rear elevational view of the clamping assembly shown in FIG. 1, with the tensioning device removed.

FIG. 4 is a cross-sectional view of the clamping assembly taken generally along line 4-4 in FIG. 3A.

FIG. 5 is a cross-sectional view of the clamping assembly taken generally along line 5-5 in FIG. 3A.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

Where used herein, the terms “first,” “second,” and so on, do not necessarily denote any ordinal, sequential, or priority relation, but are simply used to more clearly distinguish one element or set of elements from another, unless specified otherwise.

Where used herein, the term “about” when applied to a value is intended to mean within the tolerance range of the equipment used to produce the value, or, in some examples, is intended to mean plus or minus 10%, or plus or minus 5%, or plus or minus 1%, unless otherwise expressly specified.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “substantially” is intended to mean values within ten percent of the specified value.

Where used herein, the term “exemplary” is intended to mean “an example of,” “serving as an example,” or “illustrative,” and does not denote any preference or requirement with respect to a disclosed aspect or embodiment.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element. A similar interpretation is intended when the phrase “used in at least one of:” is used herein.

By “non-rotatably connected” elements, it is meant that the elements are connected so that whenever one of the elements rotate, all the elements rotate, and relative rotation between the elements is not possible. Radial and/or axial movement of non-rotatably connected elements with respect to each other is possible, but not required. By “rotatably connected” elements, it is mean that the elements are rotatable with respect to each other.

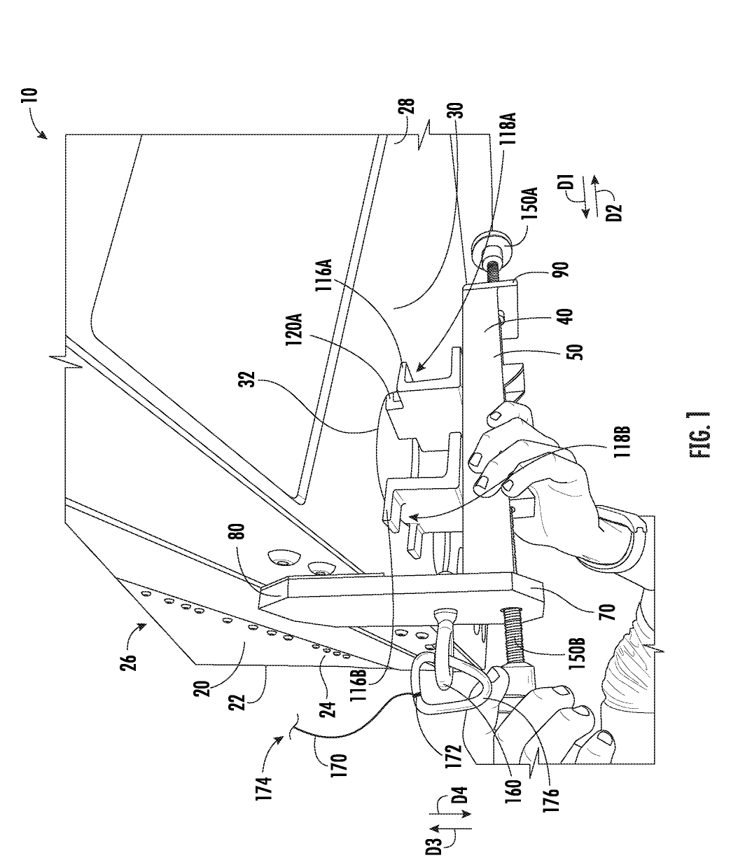

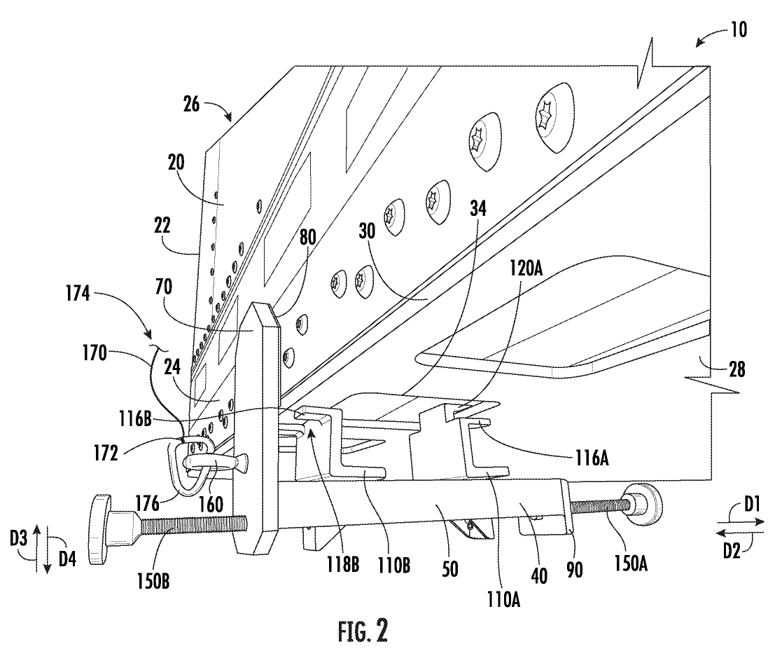

Adverting now to the figures, FIG. 1 is a front perspective view of fall restraint assembly 10, in accordance with embodiments of the present disclosure. FIG. 2 is a front perspective view of fall restraint assembly 10, in accordance with embodiments of the present disclosure. Fall restraint assembly 10 comprises clamping assembly 40. In an exemplary embodiment, fall restraint assembly 10 further comprises line 170. In an exemplary embodiment, fall restraint assembly 10 further comprises connector 176.

In some embodiments, fall restraint assembly 10 is arranged on semi-trailer or tractor-trailer 20; however, it should be appreciated that fall restraint assembly 10 can be utilized for any infrastructure where falling is a risk, for example, a building, bridge, aircraft, etc. Semi-trailer 20 comprises front (not shown), rear 22, side 24, top 26, and bottom 28. Bottom 28 is formed of and/or comprises frame or plate 30. Frame 30 comprises hole 32, 34. For example, as shown in FIG. 1, frame 30 comprises circular hole 32, and as shown in FIG. 2, frame 30 comprises square-shaped or rectangular hole 34. Clamping assembly 40 is operatively arranged to engage hole 32, 34 and/or frame 30 to secure line 170 to semi-trailer 20, as will be described in greater detail below.

Semi-trailer 20 further comprises front support or landing gear (not shown) extending in direction D4 from bottom 28. Landing gear comprises at least one leg, for example, two legs. The legs may be extendable and retractable, for example, when semi-trailer 20 is not connected to a semi-truck and connected to a semi-truck, respectively. The landing gear may comprise other support componentry known in the art, for example, leg sleeves to which the legs are telescopingly engaged, landing gear feet connected to the distal ends of the legs (and engage the ground surface), one or more gussets extending between bottom 28 and the legs to add support, additional support beams, etc. Semi-trailer 20 further comprises a rear impact guard or bumper (not shown) arranged proximate rear 22 and one or more wheels (not shown). It should be appreciated that the landing gear and bumper are fixedly secured to semi-trailer 20, for example bottom 28.

Line 170 is a cable, rope, strap, chain, string, or the like comprising end 172 and end 174. End 172 is arranged to be connected to clamping assembly 40. In an exemplary embodiment, end 172 is connected to clamping assembly 40, namely, attachment device or eyebolt or hook or loop 160, via connector 176. Connector 176 may comprise any suitable coupling link preferably with a safety closure, for example, a carabiner. In an exemplary embodiment, end 174 is arranged to be connected, either directly or indirectly, to a safety harness (not shown). It should be appreciated that ends 172 and 174 of line 170 may be connected to clamping assembly 40 and the safety harness, respectively, via any suitable means, for example, a choker hitch, a clamp, a carabiner, a J-hook, etc.

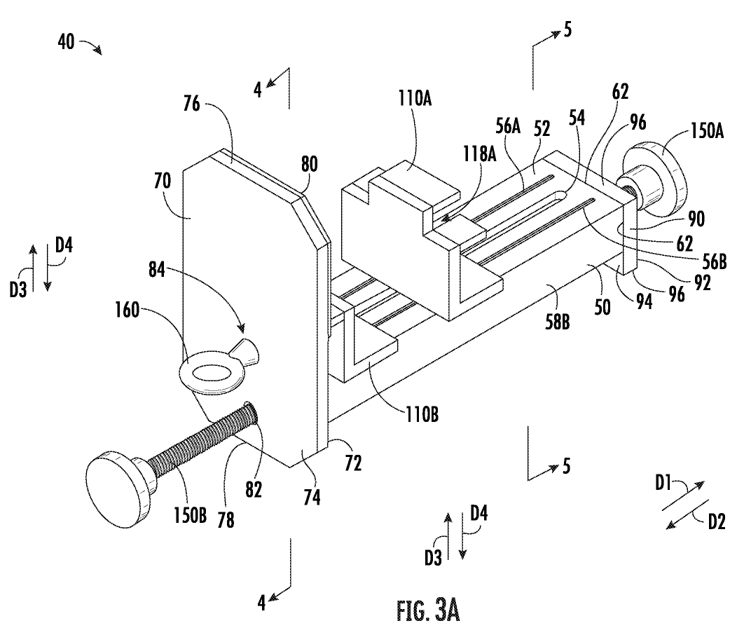

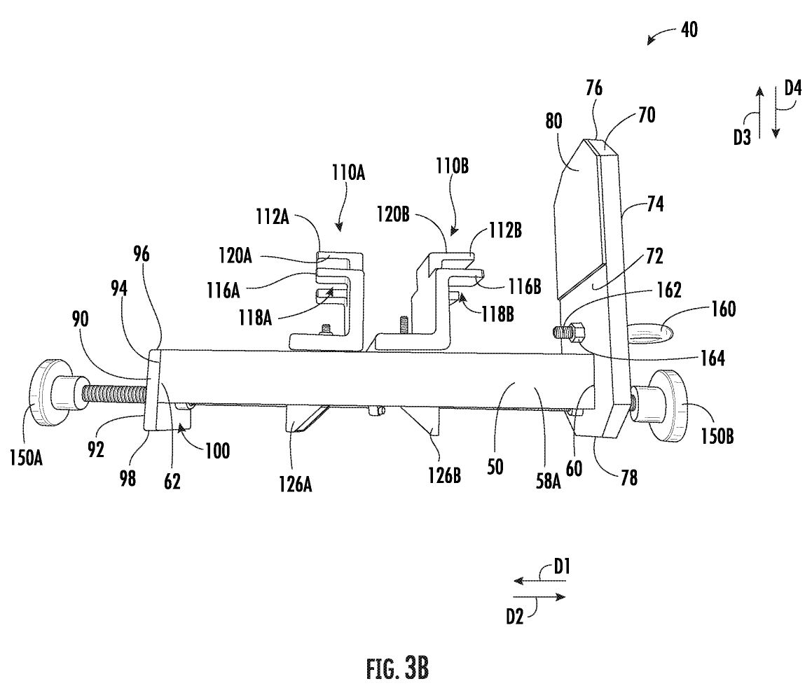

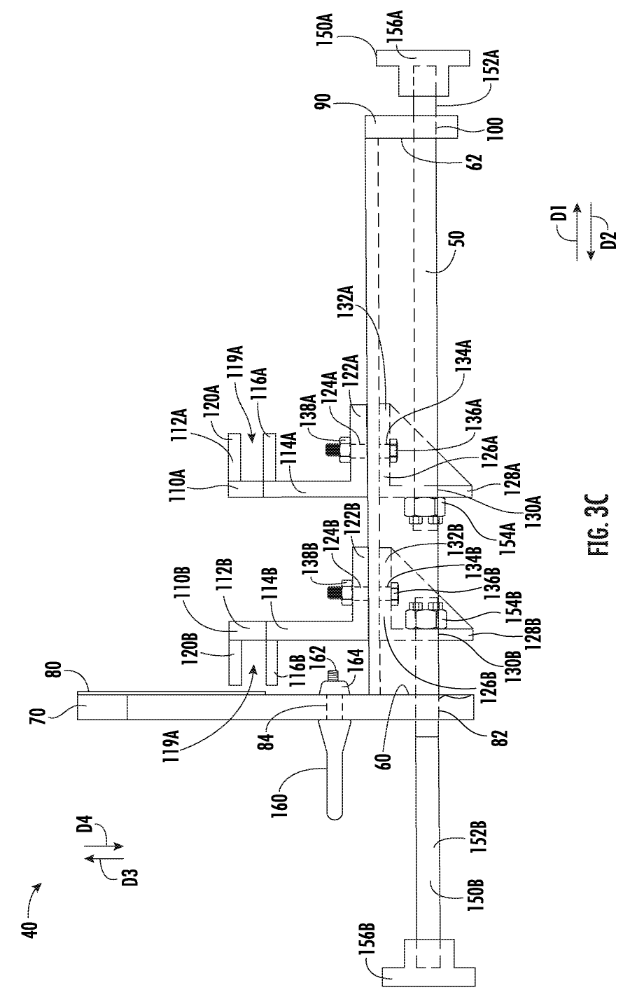

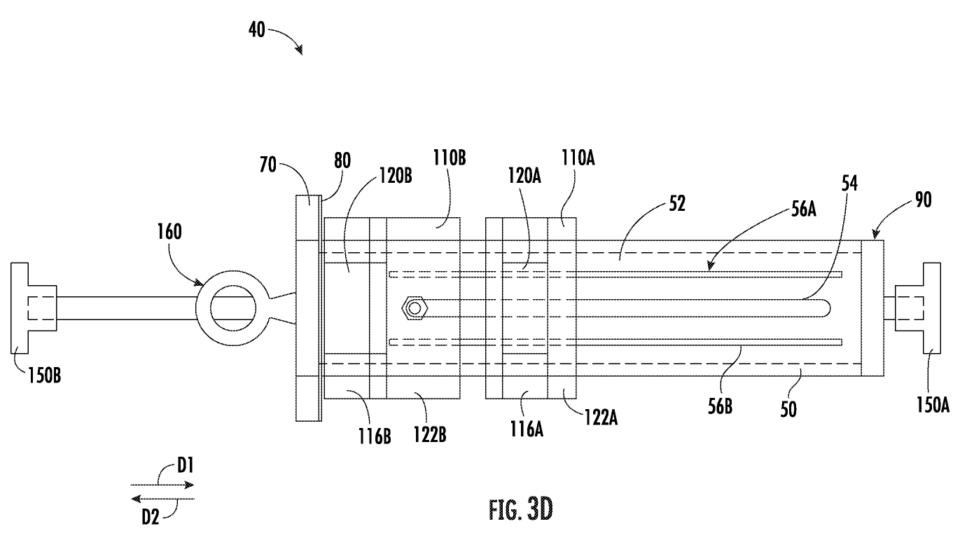

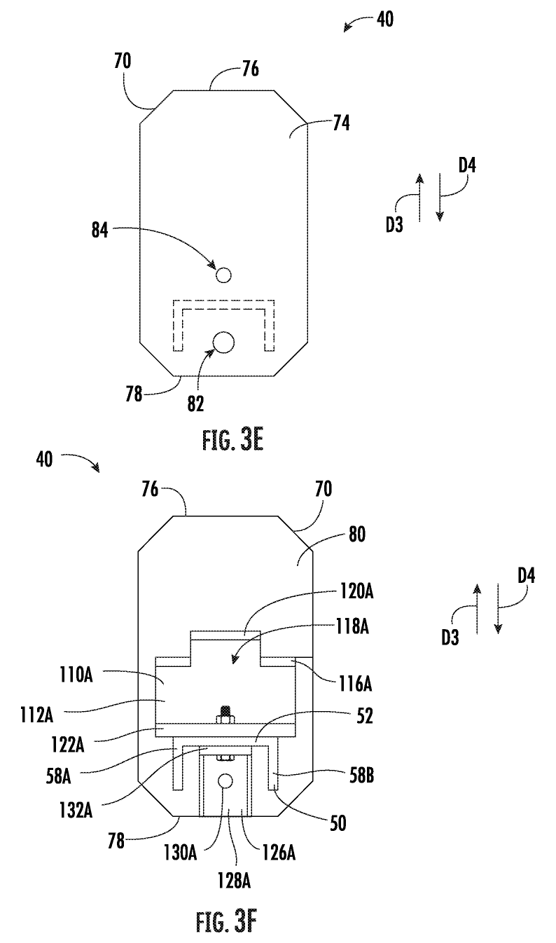

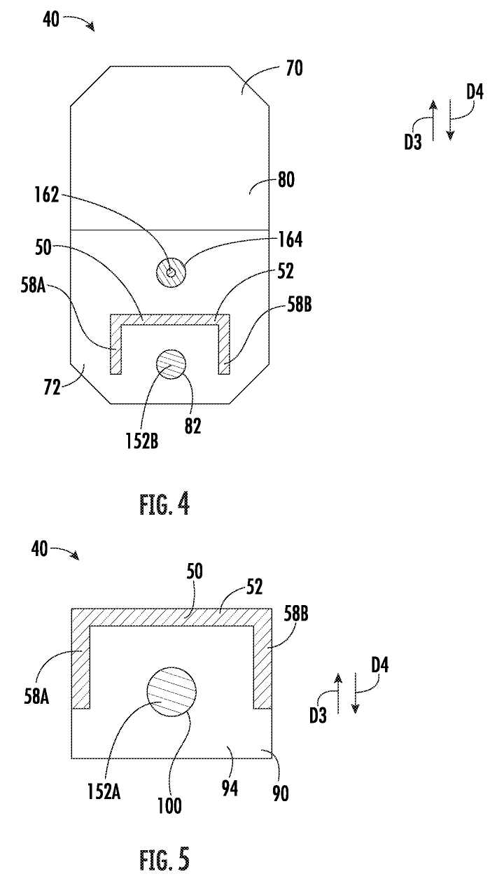

FIG. 3A is a front perspective view of clamping assembly 40. FIG. 3B is a rear perspective view of clamping assembly 40. FIG. 3C is a side elevational view of clamping assembly 40. FIG. 3D is a top plan view of clamping assembly 40. FIG. 3E is a front elevational view of clamping assembly 40, with tensioning device 150B and attachment device 160 removed. FIG. 3F is a rear elevational view of clamping assembly 40, with tensioning device 150A removed. FIG. 4 is a cross-sectional view of clamping assembly 40 taken generally along line 4-4 in FIG. 3A. FIG. 5 is a cross-sectional view of clamping assembly 40 taken generally along line 5-5 in FIG. 3A. Clamping assembly 40 generally comprises arm 50, plate 70, at least one engaging member, for example, engaging members 110A-110B, and at least one tensioning device, for example, tensioning devices 150A-150B.

Arm 50 comprises plate or top surface 52, end 60, and end 62. Plate 52 comprises slot 54 extending completely through plate 52 to facilitate connection of engaging members 110A-110B with arm 50. Slot 54 extends along plate 52 generally in direction D1, D2. In an exemplary embodiment, plate 52 further comprises one or more grooves, for example, grooves 56A-56B. Grooves 56A-56B comprise grease to facilitate sliding connection of engaging members 110A- 110B with arm 50. That is, grease is arranged in grooves 56A-56B. In an exemplary embodiment, arm 50 further comprises plate 58A and/or plate 58B extending in direction D4 from plate 52. Plate 58A is arranged on a first lateral side of plate 52 and plate 58B is arranged on a second lateral side of plate 52, opposite the first lateral side. In an exemplary embodiment, plate 58B is arranged parallel to plate 58A.

Plate 70 is connected to plate 52 at end 60. Plate 70 comprises surface 72, surface 74, top 76, and bottom 78. In an exemplary embodiment, plate 70 is fixedly secured to end 60 of arm 50. Surface 72 faces generally in direction D1 and is engaged with end 60 of arm 50. Surface 72 is operatively arranged to engage side 24 of semi-trailer 20, for example, to help stabilize clamping assembly 40. In an exemplary embodiment, surface 72 comprises gripping material or pad or strip 80 operatively arranged to prevent sliding displacement of plate 70 with respect to side 24 and the scratching of side 24 via plate 70. In an exemplary embodiment, pad 80 comprises rubber. In an exemplary embodiment, pad 80 does not cover the entirety of surface 72, but is spaced apart from bottom 78. In an exemplary embodiment, a shim (not shown) is arranged between plate 70 and/or pad 80 and side surface 24 of semi-trailer 20. In an exemplary embodiment, top 76 is arranged elevationally higher than, or spaced apart in direction D3 from, bottom 28 of semi-trailer 20, and bottom 78 is arranged elevationally lower than, or spaced apart in direction D4 from, bottom 28 of semi-trailer 20.

Plate 70 further comprises hole or through-bore 82 operatively arranged to engage tensioning device 150B. In an exemplary embodiment, through-bore 82 is a threaded hole arranged to engage threaded rod 152B such that, as threaded rod 152B is rotated in a first circumferential direction, rod 152B is displaced in direction D1, and as threaded rod 152B is rotated in a second circumferential direction opposite the first circumferential direction, rod 152B is displaced in direction D2.

Attachment device 160 is operatively arranged to be connected to plate 70. In an exemplary embodiment, plate 70 comprises hole 84 operatively arranged to facilitate connection of attachment device 160 with plate 70. For example, hole 84 may be a through-bore through which bolt 162 extends. Attachment device 160 is then secured to plate 70 via bolt 164. It should be appreciated, however, that attachment device 160 may be connected to plate 70 via any suitable means, for example, welding, brazing, adhesive, etc. Attachment device 160 facilitates the connection of line 170 to clamping assembly 40, and also acts as a standoff to prevent line abrasion and damage to trailer paint. Line protection such as coatings and concentric tubular structures (e.g., a sheath) may also be applied to prevent abrasion of the lines, to improve device longevity. For example, attachment device 160 moves the connection point of line 170 with semi-trailer 20 outward from the wheels, past the edge or side 24 of semi-trailer 20. In an exemplary embodiment, attachment device 160 comprises a threaded eye-bolt.

In an exemplary embodiment, clamping assembly 40 further comprises plate 90. Plate 90 is connected to plate 52 at end 62. Plate 90 comprises surface 92, surface 94, top 96, and bottom 98. In an exemplary embodiment, plate 90 is fixedly secured to end 62 of arm 50. Surface 94 faces generally in direction D2 and is engaged with end 62 of arm 50. In an exemplary embodiment, top 96 is aligned with the top surface of plate 52. Plate 90 further comprises hole or through-bore 100 operatively arranged to engage tensioning device 150A. In an exemplary embodiment, through-bore 100 is a threaded hole arranged to engage threaded rod 152A such that, as threaded rod 152A is rotated in a first circumferential direction, rod 152A is displaced in direction D1, and as threaded rod 152A is rotated in a second circumferential direction opposite the first circumferential direction, rod 152A is displaced in direction D2.

Engaging member 110A comprises top bracket 112A and bottom bracket 126A, and is operatively arranged to engage hole 32, 34 and/or frame or plate 30 of semi-trailer 20. Top bracket 112A is slidingly and/or translatably connected to the top surface of plate 52 and bottom bracket 126A is slidingly and/or translatably connected to the bottom surface of plate 52. Top bracket 112A comprises base 122A and post 114A. Base 122A is slidably arranged on the top surface of plate 52. In an exemplary embodiment, base 122A comprises through-hole 124A operatively arranged to engage bolt 136A to connect top bracket 112A to arm 50.

Post 114A is connected to base 122A and extends therefrom generally in direction D3. In an exemplary embodiment, post 114A is fixedly secured to base 122A at its proximal end. In an exemplary embodiment, post 114A is arranged perpendicular to base 122A. Post 114A comprises one or more fingers, for example, finger 116A and finger 120A, arranged at its distal end. Finger 116A is spaced apart from finger 120A in direction D4, forming channel 119A therebetween (i.e., channel 119A is formed between the bottom surface of finger 120A, the top surface of finger 116A, and post 114A). Channel 119A is arranged to engage plate 30 of semi-trailer 20. For example, finger 120A is arranged elevationally above plate 30 and arranged to engage a top surface thereof and finger 116A is arranged elevationally below plate 30 and arranged to engage a bottom surface thereof.

In an exemplary embodiment, finger 116A comprises space or hole 118A which separates finger 116A into two fingers. In an exemplary embodiment, space 118A is aligned with finger 120A in direction D3, D4. Thus, in such embodiment, engaging member 110A comprises three fingers, namely, one finger 120A and two fingers 116A which are spaced apart laterally and arranged on each lateral side of finger 120A. This three-finger arrangement provides a more stable connection between clamping assembly 40 and plate 30 of semi-trailer. In an exemplary embodiment, fingers 116A and 120A extend from post 114A generally in direction D1. In an exemplary embodiment, fingers 116A and/or 120A are arranged perpendicular to post 114A.

Bottom bracket 126A comprises base 132A and post 128A. Base 132A is slidably arranged on the bottom surface of plate 52. In an exemplary embodiment, base 132A comprises through-hole 134A operatively arranged to engage bolt 136A to connect bottom bracket 126A to arm 50. Specifically, bolt 134A is fed through hole 134A, slot 54, and hole 124A either in direction D3 or direction D4, and nut 138A is connected thereto thereby slidably connecting top bracket 112A and bottom bracket 126A to arm 50.

Post 128A is connected to base 132A and extends therefrom generally in direction D4. In an exemplary embodiment, post 128A is fixedly secured to base 132A at its proximal end. In an exemplary embodiment, post 128A is arranged perpendicular to base 132A. In an exemplary embodiment, bottom bracket 126A comprises one or more trusses or plates extending between post 128A and base 132A for added support. Post 128A comprises through-bore 130A operatively arranged to engage rod 152A. Specifically, threaded rod 152A is fed through hole 130A in post 128A in direction D2 and connector or nut 154A is connected to the distal end of threaded rod 152A. In an exemplary embodiment, as threaded rod 152A is displaced in direction D1 engaging member 110A is displaced in direction D1, but as threaded rod 152A is displaced in direction D2 engaging member 110A may not be displaced in direction D2. That is, bottom bracket 126A is not fixed to threaded rod 152A. In an exemplary embodiment, as threaded rod 152A is displaced in direction D1 engaging member 110A is displaced in direction D1 and as threaded rod 152A is displaced in direction D2 engaging member 110A is displaced in direction D2 (e.g., bottom bracket 126A is fixed to threaded rod 152A).

Engaging member 110B comprises top bracket 112B and bottom bracket 126B, and is operatively arranged to engage hole 32, 34 and/or frame or plate 30 of semi-trailer 20. Top bracket 112B is slidingly and/or translatably connected to the top surface of plate 52 and bottom bracket 126B is slidingly and/or translatably connected to the bottom surface of plate 52. Top bracket 112B comprises base 122B and post 114B. Base 122B is slidably arranged on the top surface of plate 52. In an exemplary embodiment, base 122B comprises through-hole 124B operatively arranged to engage bolt 136B to connect top bracket 112B to arm 50.

Post 114B is connected to base 122B and extends therefrom generally in direction D3. In an exemplary embodiment, post 114B is fixedly secured to base 122B at its proximal end. In an exemplary embodiment, post 114B is arranged perpendicular to base 122B. Post 114B comprises one or more fingers, for example, finger 116B and finger 120B, arranged at its distal end. Finger 116B is spaced apart from finger 120B in direction D4, forming channel 119B therebetween (i.e., channel 119B is formed between the bottom surface of finger 120B, the top surface of finger 116B, and post 114B). Channel 119B is arranged to engage plate 30 of semi-trailer 20. For example, finger 120B is arranged elevationally above plate 30 and arranged to engage a top surface thereof and finger 116B is arranged elevationally below plate 30 and arranged to engage a bottom surface thereof.

In an exemplary embodiment, finger 116B comprises space or hole 118B which separates finger 116B into two fingers. In an exemplary embodiment, space 118B is aligned with finger 120B in direction D3, D4. Thus, in such embodiment, engaging member 110B comprises three fingers, namely, one finger 120B and two fingers 116B which are spaced apart laterally and arranged on each lateral side of finger 120B. This three-finger arrangement provides a more stable connection between clamping assembly 40 and plate 30 of semi-trailer. In an exemplary embodiment, fingers 116B and 120B extend from post 114B generally in direction D2, opposite of fingers 120A and 116A, which extend in direction D1. This allows fingers 116A and 120A, and fingers 116B and 120B, to engage opposite sides of hole 32, 34 as engaging members 110A-110B are displaced away from each other. In an exemplary embodiment, fingers 116B and/or 120B are arranged perpendicular to post 114B.

Bottom bracket 126B comprises base 132B and post 128B. Base 132B is slidably arranged on the bottom surface of plate 52. In an exemplary embodiment, base 132B comprises through-hole 134B operatively arranged to engage bolt 136B to connect bottom bracket 126A to arm 50. Specifically, bolt 134B is fed through hole 134B, slot 54, and hole 124B either in direction D3 or direction D4, and nut 138B is connected thereto thereby slidably connecting top bracket 112B and bottom bracket 126B to arm 50.

Post 128B is connected to base 132B and extends therefrom generally in direction D4. In an exemplary embodiment, post 128B is fixedly secured to base 132B at its proximal end. In an exemplary embodiment, post 128B is arranged perpendicular to base 132B. In an exemplary embodiment, bottom bracket 126B comprises one or more trusses or plates extending between post 128B and base 132B for added support. Post 128B comprises through-bore 130B operatively arranged to engage rod 152B. Specifically, threaded rod 152B is fed through hole 130B in post 128B in direction D1 and connector or nut 154B is connected to the distal end of threaded rod 152B. In an exemplary embodiment, as threaded rod 152B is displaced in direction D2 engaging member 110B is displaced in direction D2, but as threaded rod 152B is displaced in direction D1 engaging member 110B may not be displaced in direction D1. That is, bottom bracket 126B is not fixed to threaded rod 152B. In an exemplary embodiment, as threaded rod 152B is displaced in direction D2 engaging member 110B is displaced in direction D2 and as threaded rod 152B is displaced in direction D1 engaging member 110B is displaced in direction D1 (e.g., bottom bracket 126B is fixed to threaded rod 152B).

Tensioning device 150A is operatively arranged to displace engaging member 110A into engagement with plate 30 in order to secure clamping assembly 40 to semi-trailer 20. Specifically, tensioning device 150A is arranged to displace engaging member 110A in direction D1 to engage plate 30. Tensioning device 150A comprises rod 152A including a distal end connected to bottom bracket 128A and a proximal end. In an exemplary embodiment, knob 156A is non-rotatably connected to the proximal end of rod 152A (e.g., via a set screw). As previously described, in an exemplary embodiment, rod 152A is a threaded rod that is threadably engaged with threaded through-bore 100 in plate 90. As threaded rod 152A is rotated in a first circumferential direction, for example via knob 156A, rod 152A is displaced in direction D1 with respect to plate 90, and as threaded rod 152A is rotated in a second circumferential direction rod 152A is displaced in direction D2 with respect to plate 90. In an exemplary embodiment, rod 152A is connected to bottom bracket 128A via lock nut 154A. As previously described, in an exemplary embodiment nut 154A prevents displacement of engaging member 110A in direction D2 with respect to rod 152A, but engaging member 110A is displaceable in direction D1 with respect to rod 152A (i.e., when bottom bracket 126A is not fixed to rod 152A). In an exemplary embodiment, bottom bracket 126A is fixed to rod 152A and thus cannot displace in direction D1 or direction D2 with respect thereto.

Tensioning device 150B is operatively arranged to displace engaging member 110B into engagement with plate 30 in order to secure clamping assembly 40 to semi-trailer 20. Specifically, tensioning device 150B is arranged to displace engaging member 110B in direction D2 to engage plate 30. Tensioning device 150B comprises rod 152B including a distal end connected to bottom bracket 128B and a proximal end. In an exemplary embodiment, knob 156B is non-rotatably connected to the proximal end of rod 152B (e.g., via a set screw). As previously described, in an exemplary embodiment, rod 152B is a threaded rod that is threadably engaged with threaded through-bore 82 in plate 70. As threaded rod 152B is rotated in a first circumferential direction, for example via knob 156B, rod 152B is displaced in direction D1 with respect to plate 70, and as threaded rod 152B is rotated in a second circumferential direction rod 152B is displaced in direction D2 with respect to plate 70. In an exemplary embodiment, rod 152B is connected to bottom bracket 128B via lock nut 154B. As previously described, in an exemplary embodiment nut 154B prevents displacement of engaging member 110B in direction D1 with respect to rod 152B, but engaging member 110B is displaceable in direction D2 with respect to rod 152B (i.e., when bottom bracket 126B is not fixed to rod 152B). In an exemplary embodiment, bottom bracket 126B is fixed to rod 152B and thus cannot displace in direction D1 or direction D2 with respect thereto.

To assemble, engaging members 110A-110B are displaced toward each other until the distance between the distal ends of fingers 116A, 120A and 116B, 120B is less than the diameter of hole 32, 34. Clamping assembly 40 is then inserted into hole 32, 34 until channels 119A-119B align with plate 30. Engaging member 110A is displaced in direction D1 until finger 120A engages the top surface of plate 30 and finger 116A engages the bottom surface of plate 30. Engaging member 110B is displaced in direction D2 until finger 120B engages the top surface of plate 30 and finger 116B engages the bottom surface of plate 30. In an exemplary embodiment, engaging member 110A is tightened first so that pressure plate 70 is tight and flush against side wall 24 of semi-trailer 20. Then engaging member 110B is adjusted and tightened to fit opening 32, 34 in king plate, king pin plate, frame, or plate 30. Engaging member 110A and engaging member 110B are then tightened against plate 30 via tensioning device 150A and tensioning device 150B, respectively. Clamping assembly 40 is then secured to semi-trailer 20 creating a stable and secure anchor point for a fall restraint system. Line 170 is connected to attachment device 160 and thus secured to semi-trailer 20. The arrangement of clamping device 40, namely, having adjustable sliding engaging members or forks 110A-110B, allows it to fit inside a variety of size and shaped holes and thus universal for use with nearly all trailers.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

10 Fall restraint assembly

20 Semi-trailer or tractor-trailer

22 Rear

24 Side

26 Top

28 Bottom

30 Frame

32 Hole

34 Hole

40 Clamping assembly

50 Arm

52 Plate

54 Slot

56A Groove

56B Groove

58A Plate

58B Plate

60 End

62 End

70 Plate

72 Surface

74 Surface

76 Top

78 Bottom

80 Gripping material or pad

82 Hole

84 Hole

90 Plate

92 Surface

94 Surface

96 Top

98 Bottom

100 Hole

110A Engaging member

110B Engaging member

112A Top bracket

112B Top bracket

114A Post

114B Post

116A Finger

116B Finger

118A Space

118B Space

119A Channel

119B Channel

120A Finger

120B Finger

122A Base

122B Base

124A Through-hole

124B Through-hole

126A Bottom bracket

126B Bottom bracket

128A Post

128B Post

130A Through-bore

130B Through-bore

132A Base

132B Base

134A Through-hole

134B Through-hole

136A Connector or bolt

136B Connector or bolt

138A Connector or nut

138B Connector or nut

150A Tensioning device

150B Tensioning device

152A Rod

152B Rod

154A Connector or nut

154B Connector or nut

156A Knob

156B Knob

160 Attachment device or eyebolt or hook

162 Connector or bolt

164 Connector or nut

170 Line

172 End

174 End

176 Connector

D1 Direction

D2 Direction

D3 Direction

D4 Direction

What is claimed is:

1. A clamping assembly for a fall restraint system, the clamping assembly comprising:
an arm, including:
a first end;
a second end; and
a slot;
a first engaging member slidably connected to the arm, the first engaging member displaceable in a first direction and a second direction, opposite the first direction;
a plate including a first surface connected to the first end and a second surface;
a first tensioning device operatively arranged to displace the first engaging member in the first direction; and
a coupling device connected to the second surface.

2. The clamping assembly as recited in claim 1, wherein the first engaging member comprises a first top bracket including a first finger and a second finger spaced apart from the first finger.

3. The clamping assembly as recited in claim 2, wherein the first top bracket comprises a post and the first finger and the second finger extend from the post in the first direction.

4. The clamping assembly as recited in claim 2, wherein:
the first engaging member further comprises a first bottom bracket; and
a connector extends through the first bottom bracket, the slot, and the first top bracket to slidably connect the first engaging member to the arm.

5. The clamping assembly as recited in claim 1, wherein the first tensioning device comprises a rod connected to the first engaging member.

6. The clamping assembly as recited in claim 5, wherein the rod comprises threading and is threadably engaged with the second end.

7. The clamping assembly as recited in claim 2, further comprising a second engaging member slidably connected to the arm, the second engaging member displaceable in the first direction and the second direction.

8. The clamping assembly as recited in claim 7, further comprising a second tensioning device operatively arranged to displace the second engaging member in the second direction.

9. The clamping assembly as recited in claim 7, wherein the second engaging member comprises a second top bracket including a third finger and a fourth finger spaced apart from the third finger.

10. The clamping assembly as recited in claim 7, further comprising a second tensioning device operatively arranged to displace the second engaging member in the second direction.

11. The clamping assembly as recited in claim 10, wherein the second tensioning device comprises a rod connected to the second engaging member.

12. The clamping assembly as recited in claim 11, wherein the rod comprises threading and is threadably engaged with a hole in the plate.

13. The clamping assembly as recited in claim 1, wherein the first surface comprises a rubber pad.

14. The clamping assembly as recited in claim 1, wherein the coupling device comprises an eyebolt.

15. A fall restraint assembly, comprising:
a clamping assembly, including:
an arm, comprising:
a first end;
a second end; and
a slot;
a first engaging member slidably connected to the arm, the first engaging member displaceable in a first direction and a second direction, opposite the first direction;
a plate including a first surface connected to the first end and a second surface;
a first tensioning device operatively arranged to displace the first engaging member in the first direction; and
a coupling device connected to the second surface; and
a line connected to the coupling device.

16. The fall restraint assembly as recited in claim 15, wherein the first engaging member comprises a first finger and a second finger spaced apart from the first finger, the first finger and the second finger extending in the first direction.

17. The fall restraint assembly as recited in claim 16, further comprising a second engaging member slidably connected to the arm.

18. The fall restraint assembly as recited in claim 17, wherein the second engaging member comprises a third finger and a fourth finger spaced apart from the third finger, the third finger and the fourth finger extending in the second direction.

19. The fall restraint assembly as recited in claim 17, further comprising a second tensioning device operatively arranged to displace the second engaging member in the second direction.

20. The fall restraint assembly as recited in claim 15, wherein:
the first tensioning device comprises a rod connected to the first engaging member; and
the rod is threadably engaged with one of the first end and the second end.
